(19) United States
(12) Patent Application Publication
(10) Pub. No.: US 2008/0309197 A1
(43) Pub. Date: Dec. 18, 2008

(54) Piezoelectric Actuator Having a Self-Centering Plug-In Connection

(76) Inventors: Rudolf Heinz, Renningen (DE); Dieter Kienzler, Leonberg (DE); Udo Schaich, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/064,396

(22) PCT Filed: Jul. 13, 2006
(86) PCT No.: PCT/EP2006/064208

§ 371 Date: Feb. 21, 2008

(30) Foreign Application Priority Data
Aug. 22, 2005 (DE) 102005039553.8

(51) Int. Cl. H02N 2/04

(52) U.S. Cl. 310/328

(57) ABSTRACT

The invention relates to a piezoelectric actuator used as a piezoelectric injector, comprising a holding body provided with an inner region, an upper part and a lower part, and a piezoelectric element which is arranged in the inner region against the upper part of the holding body and includes a plurality of piezoelectric layers arranged in the form of a stack, The piezoelectric element can be electrically contacted through the holding body. The upper part of the holding body has at least one connection for electrically contacting the piezoelectric element, and at least one connection and flow channels for feeding the inner chamber with a fluid that can be metered by means of a regulating element containing the piezoelectric element. An electrical plug-in connection is arranged between the piezoelectric element and the upper part of the holding body, which includes a mechanical plug-in connection being arranged between the holding body upper part and the piezoelectric element.

### FIELD OF THE INVENTION

The invention relates to a piezoelectric actuator, preferably a piezoelectric injector, for actuating a mechanical component such as a valve, nozzle needle, or the like, as generically defined by the preamble to claim 1.

### BACKGROUND OF THE INVENTION

It is known per se that for constructing a piezoelectric actuator or piezoelectric injector, a piezoelectric element can be inserted in such a way that by using what is known as the piezoelectric effect, control of the needle stroke of a valve or the like can be accomplished. The piezoelectric element is constructed from a material of a suitable crystalline structure such that when an external electrical voltage is applied, a mechanical reaction of the piezoelectric element ensues that, depending on the crystalline structure and the regions contacted by the electrical voltage, represents compression or tension in a predeterminable direction. Such piezoelectric actuators are suitable for instance for applications in which reciprocating motions take place under strong actuating forces and at high cycle frequencies.

One such piezoelectric injector is known for instance from German Patent Disclosure DE 100 26 005 A1, and can be used for triggering the nozzle needle in injectors for injecting fuel into the combustion chamber of an internal combustion engine. In this piezoelectric actuator, a piezoelectric element is constructed as noted as a stack of a plurality of electrically coupled piezoceramic layers that is held with initial tension between two stops. Each piezoceramic layer is enclosed as a piezoelectric layer between two internal electrodes by way of which an electrical voltage can be applied from outside. Because of this electrical voltage, the piezoceramic layers then each execute small reciprocating motions in the direction of the potential gradient, and these add up to the total stroke of the piezoelectric actuator. This total stroke is variable by way of the magnitude of the voltage applied and can be transmitted to a mechanical final control element.

In European Patent Disclosure EP 1 174 615 A3, a piezoelectric actuator is also described in which a piezoelectric element is present as an actuator for direct needle stroke control of an injector for an internal combustion engine. Between the piezoelectric element as an actuator and the needle, there is only a coupler, with a hydraulic boost for strain equalization. Upon activation of the piezoelectric element, the needle, held with initial tension to close the injection nozzle, is moved away from the nozzle opening, since the needle follows the motion of the actuator with direct boosting. The piezoelectric element, coupler, and needle form parts of a final control element with the aid of which fuel in an injector, for instance, or some other fluid, can be injected in metered into the combustion chamber of an internal combustion engine, for instance.

In FIG. 3, a basic construction of a single-stage piezoelectric actuator 1 of the prior art is shown, which can be used for instance for needle stroke control in the fuel injection system in an internal combustion engine. In the upper part there is a holding body 2, which can be adapted in its geometric dimensions essentially to the particular intended use and the specific site where it will be used. An electrical connection chamber for a plug part, not shown here, is present on the holding body 2, and by means of it, with a plug embodiment likewise specifically adapted to the particular application, the electrical voltage can be connected for triggering a piezoelectric element 3 located in an inner chamber 4 of the holding body 2. From the plug part, wires not shown here are extended as electrical lines to external electrodes, also not shown, on the piezoelectric element 3, for electrically contacting the piezoelectric element 3. The piezoelectric element 3, upon actuation, acts on a nozzle needle 6, via a mechanical arrangement located vertically below it in this case, with a coupler 5, that opening of a nozzle opening 7 can be accomplished here. Fuel carried in the interior of the piezoelectric actuator 1 through the inner chamber 4 in the holding body 2 can thus be injected into the combustion chamber of an internal combustion engine, not shown here.

In FIG. 3, the piezoelectric element 3, via an actuator foot 8, rests above on a ball-like sealing seat in the inner chamber 4 in the holding body 2, and for achieving a good sealing seat, a spring 9 is pressed against the piezoelectric element 3. Particularly in so-called common rail (CR) systems, high-pressure sealing from an electrical connection chamber, located above the piezoelectric element 3 and above the inner chamber 4 in the holding body 2, is necessary, through which connection chamber the electrical lines for electrically contacting the piezoelectric element 3 are carried.

Installation-specific requirements of piezoelectric actuators can be met more easily and less expensively with a two-piece holding body that includes both an upper part of the holding body and a lower part of the holding body. The upper part of the holding body is adapted predominantly to the external peripheral conditions that are predetermined by the specific installation conditions and essentially receives the external terminals for electrically contacting the piezoelectric element and for the fluid, such as a fuel, to be metered, along with the electrical lines serving to provide electrical contact and extending through the upper part of the holding body, as well as the flow conduit that connects the inner chamber with the connection for the fluid.

The lower part of the holding body, by comparison, is predominantly adapted to the peripheral conditions predetermined by the dimensions and geometry of the piezoelectric element and the flow course of the fluid in the inner chamber and essentially receives the inner chamber as well as the piezoelectric element located in it.

To make it possible, before the final assembly of the piezoelectric actuator, for the electrical lines leading through the upper part of the holding body and forming the electrical contact to be tested for function and especially for a tight seal from the outside with respect to the fluid carried at high pressure in the inner chamber, the piezoelectric element is preferably disposed on the upper part of the holding body by means of an electrical plug-in connection.

This electrical plug-in connection is subject to strong mechanical loads, which can lead to a mechanical failure of the electrical plug-in connection, that is, in the case of a piezoelectric element that can be connected solidly to the upper part of the holding body particularly during the assembly of the piezoelectric actuator, for instance upon welding or adhesive bonding of the actuator foot of the piezoelectric element to the upper part of the holding body, or in the case of a piezoelectric element disposed detachably on the upper part of the holding body, particularly during piezoelectric actuator operation.

Moreover, particularly in an automated process, the assembly of the piezoelectric element and upper part of the holding body is made more difficult because the electrical plug-in connection must be aligned precisely before the two parts are joined together, since if they are mispositioned while being joined together, the result can be mechanical damage or even destruction of the electrical plug-in connection.

### DISCLOSURE OF THE INVENTION

The disadvantages resulting from the problems in the prior art are overcome, a piezoelectric actuator of the invention, preferably a piezoelectric injector of the type defined at the outset, by a mechanical plug-in connection that is disposed between the upper part of the holding body and the piezoelectric element and that can withstand in particular shear forces that act between the piezoelectric element and the upper part of the holding body.

Compared to the prior art, the invention has the advantage that particularly in welding or adhesive bonding of the piezoelectric element to the upper part of the holding body, the electrical plug-in connection is relieved with respect to mechanical stresses by the mechanical plug-in connection; as a result, the risk of damage or even destruction of the electrical plug-in connection is reduced markedly. Moreover, embodiments of the mechanical plug-in connection are conceivable which protect the electrical plug-in connection even in the as yet unassembled state of the piezoelectric element to the upper part of the holding body, for instance because the mechanical plug-in connection, on the component on which the electrical plug-in connection has protruding prongs and/or prong sheaths, also has protrusions that preferably protrude past the prongs and/or prong sheaths of the electrical plug-in connection. This facilitates handling the various components during the process of producing the piezoelectric actuator of the invention.

An advantageous embodiment of the invention provides that the mechanical plug-in connection includes a centering device that centers at least the piezoelectric element and the upper part of the holding body relative to one another. In this respect, it is conceivable for the mechanical plug-in connection to include a separate centering device, or a centering device that is combined with the mechanical plug-in connection. Because of the simultaneous centering of the piezoelectric element relative to the upper part of the holding body by means of the mechanical plug-in connection, the two parts on being joined together do not have to be oriented so precisely to one another during the production process and thus can be handled more simply.

A further advantageous embodiment of the invention provides that the centering device positions the electrical plug-in connection positionally correctly during the joining and centering of the piezoelectric element with the upper part of the holding body. As a result, mispolarization of the piezoelectric element even during the Joining together of the mechanical plug-in connection is prevented. The positionally correct positioning is conceivable for instance by means of a mechanical plug-in connection which has lugs with different cross-sectional dimensions that have to be introduced into corresponding recesses on the respective diametrically opposed component. Simultaneous centering can be attained for instance by means of a conical narrowing of the ends of the lugs facing toward the respective other component.

Another advantageous embodiment of the invention provides that the mechanical plug-in connection includes at least one sleeve disposed coaxially to the electrical plug-in connection. The sleeve is preferably embodied as a centering sleeve. It is conceivable for the sleeve to be made from a ceramic material.

In an especially advantageous embodiment of the invention the mechanical plug-in connection is part of the electrical plug-in connection, and the electrical plug-in connection for instance includes at least one sleeve that can withstand mechanical loads.

The electrical plug-in connection is preferably embodied as a poka-yoke plug-in connection for a correctly polarized assembly of the piezoelectric element and upper part of the holding body.

An advantageous embodiment of the invention provides that the piezoelectric element includes an actuator foot that closes off the stack 31 of piezoelectric layers in the direction of the holding body; the actuator foot can be connected solidly to the holding body, and the mechanical plug-in connection, embodied preferably as a sleeve or centering sleeve, is fixedly disposed in the actuator foot. It is conceivable that in the case of a mechanical plug-in connection that is combined with a centering device, the actuator foot is simultaneously centered relative to the stack 31 of piezoelectric layers. Because the combined plug-in connection and centering device, preferably embodied as a centering sleeve, are integrated with the actuator foot, the installation space in the upper part of the holding body for the electrical lines that extend through that upper part is sufficient, and there is no risk that the centering sleeve, the electrical lines, and the flow conduit will collide. The actuator foot is solidly joined to the holding body, for instance by means of a welded connection and/or an adhesive connection.

### BRIEF DESCRIPTION OF THE DRAWINGS

Shown are:

FIG. 1, a longitudinal section through a piezoelectric actuator of the invention, with a two-piece holding body, which includes an upper part of the holding body and a lower part of the holding body, and with a mechanical plug-in connection, which is disposed between the upper part of the holding body and a piezoelectric element in the holding body, includes a centering device, and is a component of an electrical plug-in connection;

FIG. 2, a detail of the plug-in connection of FIG. 1; and

FIG. 3, a piezoelectric actuator in accordance with the prior art.

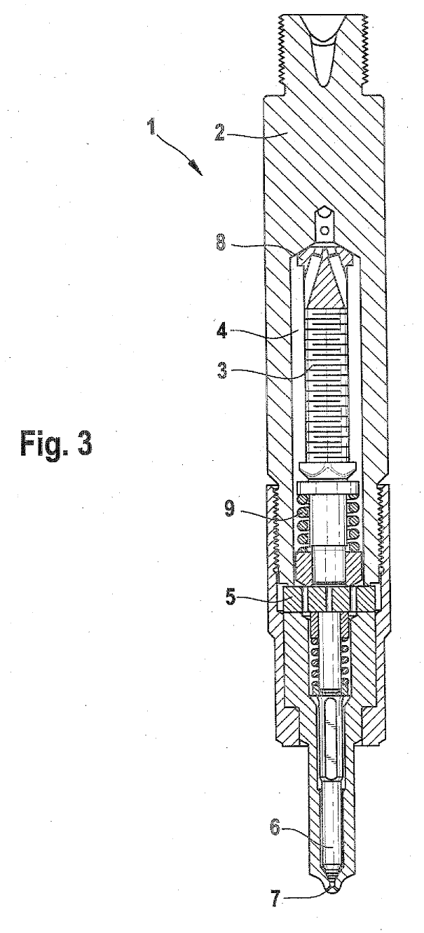

### EMBODIMENT(S) OF THE INVENTION

The invention will be described below taking as an example a piezoelectric actuator for use as a common-rail injector with direct needle control.

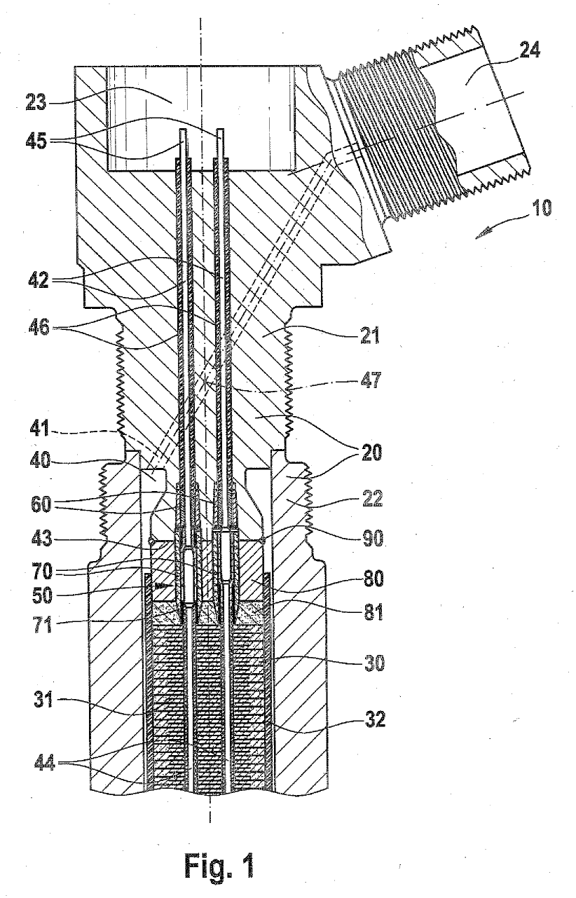

A piezoelectric actuator 10 according to the invention, shown in FIG. 1, essentially comprises a two-piece holding body 20, which has an inner chamber 40, and a piezoelectric element 30, which is disposed in the inner chamber and can be electrically contacted through the holding body 20. The piezoelectric element includes a plurality of piezoelectric layers disposed in a stack 31. The holding body 20 includes an upper part 21 and a lower part 22.

The upper part 21 of the holding body has an electrical connection chamber 23 for electrically contacting the piezoelectric element 30 by means of electrical lines 42 that extend through the upper part 21 of the holding body and end in the electrical connection chamber 23. The upper part 21 of the holding body furthermore has a connection chamber 24 for delivering a fuel, which can be metered by means of a final control element that includes the piezoelectric element 30, into the inner chamber 40, as well as a flow conduit 41 leading from the connection chamber 24 into the inner chamber 40.

The lower part 22 of the holding body essentially forms the inner chamber 40 that concentrically receives the piezoelectric element 30. The lower part 22 of the holding body defines the inner chamber 40 and thus essentially fixes the length and cross section of the inner chamber 40, while conversely the upper part 21 of the holding body defines the inner chamber 40 on one side, that is, the face end. Essentially, the electrical lines 42, the flow conduit 41, and the connection chambers 23, 24 are disposed in the upper part 21 of the holding body. As a result, a modular construction of arbitrary piezoelectric actuators 10 by combining various upper parts 21 of the holding body and lower parts 22 of the holding body is possible.

The electrical connection chamber 23 is disposed in the axial extension of the piezoelectric element 30. The fuel connection chamber 24 is disposed laterally on the upper part 21 of the holding body. The flow conduit 41 that connects the fuel connection chamber 24 with the inner chamber 40 intersects the electrical lines 42 at the intersection point 47, and as a result the installation space for electrically contacting the piezoelectric element is highly restricted.

The flow conduit 41 discharges into the annular chamber of the inner chamber 40 that remains between the piezoelectric element 30 and the lower part 22 of the holding body that concentrically envelops the piezoelectric element 30. In operation, the piezoelectric element 30, including an insulation sleeve 32 that corresponds in its internal cross-sectional dimensions to the external cross-sectional dimensions of the piezoelectric element 30, is thus surrounded by fuel flowing through the remaining annular chamber of the inner chamber 40.

The piezoelectric element 30 is electrically connected to the lines 42, disposed in the upper part 21 of the holding body, by means of an electrical plug-in connection 50.

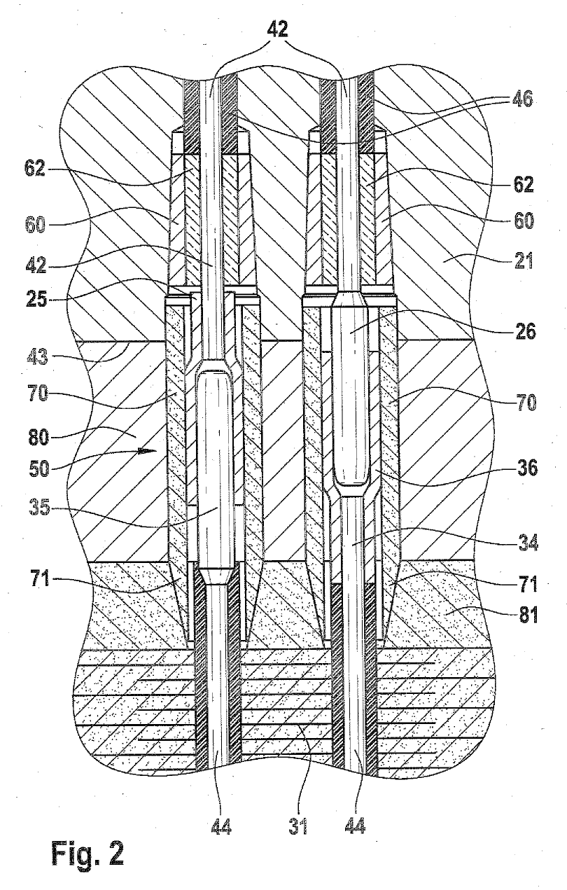

The electrical plug-in connection 50, shown in FIG. 2, is disposed between the upper part 21 of the holding body and the piezoelectric element 30. The piezoelectric element 30 includes, first, an actuator foot 80, which closes off the stack 31 of piezoelectric layers, not shown in detail, on its face end in the direction toward the upper part 21 of the holding body, the prong 35 and the prong sheath 36 that form the part toward the piezoelectric element of the electrical plug-in connection 50 being disposed on this actuator foot, and second, a ceramic insulator 81 disposed between the actuator foot 80 and the stack 31 of piezoelectric layers. Electrodes 44 serve the purpose of internally contacting the piezoelectric layers. The part of the plug-in connection 50 toward the holding body is disposed on an end wall 43 of the upper part 21 of the holding body, this end wall defining the inner chamber 40 on the face end.

The prong sheath 25 and the prong 26, which are the counterparts of the prong 35 and the prong sheath 36, are disposed in the upper part 21 of the holding body.

Also disposed between the piezoelectric element 30 and the upper part 21 of the holding body is a mechanical plug-in connection, which particularly during the assembly of the piezoelectric element 30 and upper part 21 of the holding body transmits shear forces that occur between the two parts and thus keeps them away from the electrical plug-in connection 50.

The mechanical plug-in connection is embodied as a component of the electrical plug-in connection 50 and essentially comprises two centering sleeves 70. The conically tapering centering sleeves 70 are each disposed concentrically to the prong sheath 36, disposed on the piezoelectric element 30, and to the prong 35 as well as concentrically to the prong 26, disposed on the upper part 21 of the holding body, and to the prong sheath 25. The result is an electrical plug-in connection 50 with an integrated mechanical plug-in connection and integrated centering. The centering sleeves 70 protrude from the actuator foot 80 into the upper part 21 of the holding body. They are fixedly disposed in the actuator foot 80. As a result, a large amount of installation space remains in the upper part 21 of the holding body for the parts of the plug-in connection 50 disposed there, such as the prong 26 of the holding body and the plug bush 25, and the disposition of the electrical lines, as well as for the flow conduit 41, especially with a view to the location of the point 47 of intersection with the electrical lines 42.

The centering sleeves 70 furthermore protrude, each with a conically tapering end 71, into a corresponding respective recess in the ceramic insulator 81, the recess being disposed concentrically to the prong 35 of the piezoelectric element and to the prong sheath 36 in the ceramic insulator 81. As a result, the actuator foot 80 is moreover centered relative to the ceramic insulator 81 and thus relative to the stack 31 of piezoelectric layers.

The prong sheath 25 of the holding body and the prong 26 of the holding body are connected electrically conductively to the electrical lines 42 that lead through bores disposed in the upper part 21 of the holding body. The free ends 45, facing away from the plug-in connection 50, of the electrical lines 42 are provided with insulators 46 for electrical insulation from the upper part 21 of the holding body and can be put into electrical contact with a plug in the connection chamber 23.

To prevent fuel from escaping from the inner chamber 40 into the electrical connection chamber 23, sealing bushes 60 that are joined in fuel-tight fashion to the electrical lines 40 by means of a fused-glass seal 62 are hydraulically pressed into the upper part 21 of the holding body.

For further improving the sealing of the inner chamber 40 from the electrical connection chamber and the environment, the piezoelectric element 30 is fixedly disposed on the end wall 43, defining the inner chamber 40 on the face end, of the upper part 21 of the holding body. For the fixed disposition of the piezoelectric element 30 on the end wall 43 of the upper part 21 of the holding body, a welded connection 90 is employed that connects the actuator foot 80 solidly to the end wall 43.

Alternatively, the piezoelectric element 30 can be joined solidly to the upper part 21 of the holding body by means of an adhesive connection between the actuator foot 80 and the end wall 43.

By means of a solid, encompassing connection, such as the welded connection 90, absolute high-pressure tightness of the inner chamber 40 with respect to the electrical connection chamber 23 and to the environment is attained.

By means of the combined electrical plug-in connection 50 with an integrated mechanical plug-in connection and centering, a positionally correct, centered joining together of the piezoelectric element 30 to the upper part 21 of the holding body is made possible. After that, precise welding of the actuator foot 80 to the upper part 21 of the holding body is possible.

It is important to note that by means of the invention, a safe and secure electrical plug-in connection with an integrated mechanical plug-in connection and integrated centering between the actuator foot 80 and the upper part 21 of the holding body as well as centering of the actuator foot 80 relative to the stack 31 of piezoelectric layers can be produced.

Two symmetrical small bores, leading through the upper part 21 of the holding body, for the electrical lines 42 can be made from above or below, or from both above and below, as a result of which the length of the upper part 21 of the holding body can be adapted to suit the particular application of the piezoelectric actuator 10 and its particular installation situation.

The combined plug-in and centering unit according to the invention, including the electrical plug-in connection 50, the mechanical plug-in connection, and the centering device, is fully integrated with the actuator foot 80 of the piezoelectric element 30 and includes centering of the actuator foot 80 with respect to the stack 31 of piezoelectric layers by means of the two cones 71 of the centering sleeves 70. Because the centering sleeves 70 protrude farther from the piezoelectric element 30, on the side of the actuator foot 80 facing away from the stack 31 of piezoelectric layers, than the prong 35 or the prong sheath 36, there is no risk that the prong 35 or prong sheath 36 will become bent during handling of the piezoelectric element 30 and in the joining of the piezoelectric element 30 to the upper part 21 of the holding body.

Because the combined plug-in and centering unit is integrated with the actuator foot 80 of the piezoelectric element 30, there is more installation space available in the upper part 21 of the holding body for the electrical lines 42, the part of the electrical plug-in connection 50 toward the holding body that includes the prong 26 and prong sheath 25, and the flow conduit. As a result, the risk of collision between the flow conduit 41 and the electrical lines 42 in the upper part 21 of the holding body can be reduced.

Because of the centering sleeves 70 of the combined plug-in and centering unit of the invention, when the piezoelectric element 30 to the upper part 21 of the holding body are put together, the centering of the two parts relative to one another occurs simultaneously.

The electrical plug-in connection in FIG. 2 is embodied as a poka-yoke for correctly polarized assembly.

The piezoelectric element 30 is equipped with the passive ceramic insulator 81, the pin 34 with the prong sheath 36 soldered to it, and the prong 35. The ceramic centering sleeves 70 are inserted via the prong sheath 36 and the prong 35 and centered in a conical recess located in the actuator foot 80. The actuator foot 80 is placed over the ceramic centering sleeves 70 and adhesively bonded into a unit with the ceramic insulator and the stack 31 of piezoelectric layers.

The piezoelectric element can now be polarized via the prong sheath 36 and the prong 35; for instance, the prong sheath 36 is the positive pole and the prong 35 is the negative pole. The asymmetry of the two plug contacts represents a safe and secure poka-yoke connection.

The two sealing bushes 60 are hydraulically pressed into the upper part 21 of the holding body and assure the requisite absolute pressure-tightness of the inner chamber 40 from the outside with respect to both the electrical connection chamber 23 and the environment.

The upper part 21 of the holding body can now be individually checked for pressure-tightness.

The insulators 46 are placed in the upper part 21 of the holding body, as are the electrical lines 42. The electrical lines 42 can thereupon be put into electrical contact in the electrical connection chamber 23.

Positionally correct centering of the piezoelectric element 30 with respect to the upper part 21 of the holding body is accomplished by way of the two ceramic centering sleeves 70 protruding from the actuator foot 80 into the upper part 21 of the holding body; after that, the welded connection 90 between the actuator foot 80 and the upper part 21 of the holding body can be made.

### INDUSTRIAL APPLICABILITY

The invention is industrially applicable particularly in the field of producing piezoelectric actuators for use in conjunction with injectors for internal combustion engines.

1-11. (canceled)

12. A piezoelectric actuator, comprising:
a holding body having an upper part and a lower part;
an inner chamber disposed between the upper part and the lower part of the holding body;
a piezoelectric element disposed in the inner chamber and disposed on the upper part of the holding body;
at least one terminal disposed in the upper part of the holding body, said terminal provided with electrical contacts which connect to the piezoelectric element through the holding body;
an electrical plug-in connection is disposed between the piezoelectric element and the upper part of the holding body; and
a mechanical plug-in connection disposed between the upper part of the holding body and the piezoelectric element.

13. The piezoelectric actuator according to claim 12, wherein the mechanical plug-in connection includes a centering device.

14. The piezoelectric actuator according to claim 13, wherein the electrical plug-in connection is accurately aligned by means of the centering device during joining and centering of the piezoelectric element with the upper part of the holding body.

15. The piezoelectric actuator according to claim 12, wherein the mechanical plug-in connection includes at least one sleeve disposed concentrically to the electrical plug-in connection.

16. The piezoelectric actuator according to claim 13, wherein the mechanical plug-in connection includes at least one sleeve disposed concentrically to the electrical plug-in connection.

17. The piezoelectric actuator according to claim 14, wherein the mechanical plug-in connection includes at least one sleeve disposed concentrically to the electrical plug-in connection.

18. The piezoelectric actuator according to claim 15, wherein the sleeve is embodied as a centering sleeve.

19. The piezoelectric actuator according to claim 16, wherein the sleeve is embodied as a centering sleeve.

20. The piezoelectric actuator according to claim 17, wherein the sleeve is embodied as a centering sleeve.

21. The piezoelectric actuator according to claim 18, wherein the sleeve is made from a ceramic material.

22. The piezoelectric actuator according to claim 12, wherein the mechanical plug-in connection is part of the electrical plug-in connection.

23. The piezoelectric actuator according to claim 13, wherein the mechanical plug-in connection is part of the electrical plug-in connection.

24. The piezoelectric actuator according to claim 14, wherein the mechanical plug-in connection is part of the electrical plug-in connection.

25. The piezoelectric actuator according to claim 12, wherein the electrical plug-in connection is embodied as a poka-yoke plug-in connection.

26. The piezoelectric actuator according to claim 13, wherein the electrical plug-in connection is embodied as a poka-yoke plug-in connection.

27. The piezoelectric actuator according to claim 14, wherein the electrical plug-in connection is embodied as a poka-yoke plug-in connection.

28. The piezoelectric actuator according to claim 12, further comprising an actuator foot disposed between the piezoelectric element and the upper part of the holding body, wherein the actuator foot can be solidly joined to the upper part of the holding body and wherein the mechanical plug-in connection is disposed fixedly in the actuator foot.

29. The piezoelectric actuator according to claim 13, further comprising an actuator foot disposed between the piezoelectric element and the upper part of the holding body, wherein the actuator foot can be solidly joined to the upper part of the holding body and wherein the mechanical plug-in connection is disposed fixedly in the actuator foot.

30. The piezoelectric actuator according to claim 28, wherein the actuator foot is solidly connected to the upper part of the holding body by means of a welded connection.

31. The piezoelectric according to claim 28, wherein the actuator foot is solidly connected to the upper part of the holding body by means of a adhesive connection.
